(19) United States
(12) Patent Application Publication
(10) Pub. No.: US 2017/0262435 A1
(43) Pub. Date: Sep. 14, 2017

(54) LANGUAGE PROCESSING APPARATUS AND LANGUAGE PROCESSING METHOD

(71) Applicant: KABUSHIKI KAISHA TOSHIBA, Tokyo (JP)

(72) Inventor: Satoshi Sonoo, Chigasaki Kanagawa (JP)

(21) Appl. No.: 15/419,327

(22) Filed: Jan. 30, 2017

(30) Foreign Application Priority Data
Mar. 11, 2016 (JP) 2016-048671

(51) Int. Cl. G06F 17/28; G06K 9/34; G06F 17/27

(52) U.S. Cl. CPC G06F 17/2836; G06F 17/2863; G06F 17/2755; G06K 9/344; G06F 17/2765; G06F 17/2818; G06F 17/2881; G06K 2209/01

(57) ABSTRACT

According to an embodiment, a language processing apparatus includes a recognizer and a generator. The recognizer recognizes a first character string of a first language from first data associated with a first time and recognizes a second character string of the first language including a first overlapping character string which overlaps with the first character string from second data associated with a second time later than the first time. The generator applies a production rule to the first character string and the second character string to generate a first resultant character string of the first language including the first overlapping character string.

### CROSS-REFERENCE TO RELATED APPLICATIONS

This application is based upon and claims the benefit of priority from Japanese Patent Application No. 2016-048671, filed Mar. 11, 2016, the entire contents of which are incorporated herein by reference.

### FIELD

Embodiments relate to language processing.

### BACKGROUND

In recent years, a technique of recognizing a character string from an image captured by a camera device incorporated in a mobile terminal and machine-translating the character string is known. Generally, the technique performs character recognition in units of character strings displayed in an image. With regard to a character string that does not form a sentence, a technique of machine translation by determining a break in the character string using a morphological analysis, a font size, and a character position is known. Also known are a technique of determining a continuous character region by combining a plurality of images including character strings, and a technique for improving accuracy of determination of a break in a character string by connecting lines of adjacent character strings.

However, the above techniques are based on the premise that all character strings are displayed at a time. For example, the techniques described above cannot correctly recognize a character string that scrolls in a guidance display board in an airport or a station. Furthermore, there is a risk that the techniques may produce an incorrect translation result by subjecting a partial character string in a scroll to translation processing.

### BRIEF DESCRIPTION OF THE DRAWINGS

FIG. 1 is a diagram illustrating a language processing apparatus according to a first embodiment.

FIG a flowchart illustrating an operation of the language processing apparatus shown in FIG. 1.

FIG. 3A is a diagram illustrating a guidance display board.

FIG. 3B is a diagram illustrating the entire text of a character string to be scrolled.

FIG. 4A is a diagram illustrating time series data.

FIG. 4B is a diagram illustrating image-capture times and character strings stored in a buffer.

FIG. 5 is a diagram illustrating production rules.

FIG. 6A is a diagram illustrating a language model.

FIG. 6B is a diagram illustrating resultant character strings and scores.

FIG. 7 is a diagram illustrating resultant character strings and translated character strings.

FIG. 8 is a diagram illustrating a language processing apparatus according to a second embodiment.

FIG. 9 is a diagram illustrating translated image data.

### DETAILED DESCRIPTION

Hereinafter, embodiments will be described with reference to the drawings.

According to an embodiment, a language processing apparatus includes a recognizer and a generator. The recognizer recognizes a first character string of a first language from first data associated with a first time and recognizes a second character string of the first language including a first overlapping character string which overlaps with the first character string from second data associated with a second time later than the first time. The generator applies a production rule to the first character string and the second character string to generate a first resultant character string of the first language including the first overlapping character string.

In the following, the same or similar constituent elements are denoted by the same or similar respective reference numbers, therefore redundant explanations will be avoided in principle.

In the following explanation, a source language (a first language) is Japanese, and a target language (a second language) is Chinese. However, the first language and the second language are not limited to these, and may be any other various languages.

### First Embodiment

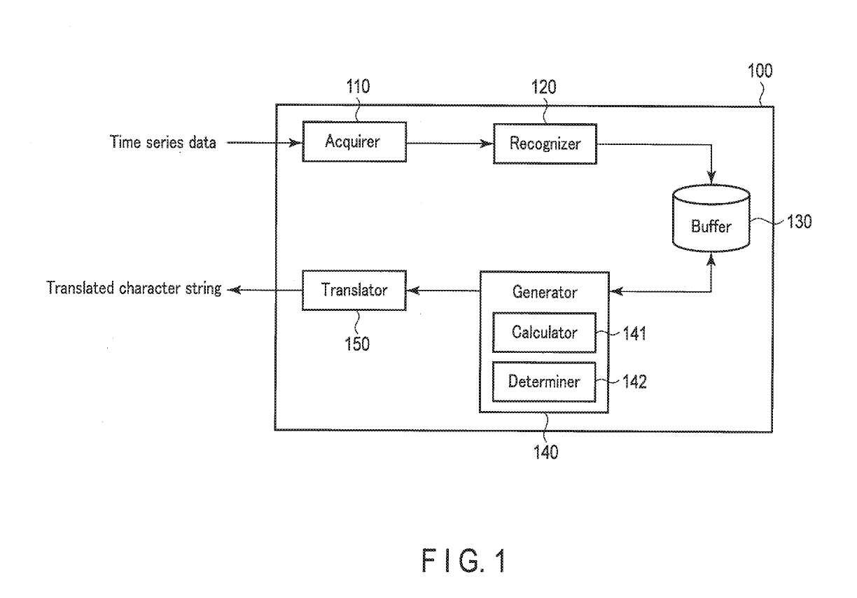

As illustrated in FIG. 1, a language processing apparatus 100 of the first embodiment comprises an acquirer 110, a recognizer 120, a buffer 130, a generator 140, and a translator 150. The generator 140 comprises a calculator 141 and a determiner 142.

The acquirer 110 acquires time series data including first data corresponding to a first time and second data corresponding to a second time. The second time is, for example, later than the first time. The time series data may further include third data corresponding to a third time later than the first time. The acquirer 110 outputs the time series data to the recognizer 120.

The time series data may be, for example, image data, frame image data, and voice data, which includes character information. Image data is acquired by, for example, continuously capturing images of an object including character information. Frame data is acquired by, for example, cutting any frame from a moving picture acquired by movie-recording an object including character information. Voice data is acquired by, for example, recording voices. The voice data may be divisional data composed of first data and second data, in which the second data includes part identical to part of the first data.

The recognizer 120 receives the time series data from the acquirer 110. The recognizer 120 recognizes, from the time series data including the first data corresponding to the first time and the second data corresponding to the second time, a first character string corresponding to the first data and a second character string corresponding to the second data. The first character string is a character string of the first language, and the second character string is a character string of the first language including a part identical to a part of the first character string. The recognizer 120 may further recognize a third character string corresponding to the third data and including a part identical to a part of the first character string.

The recognizer 120 may recognize a character string through a character recognition process using, for example, an optical character recognition technique, or through a voice recognition process using any known technique. The recognizer 120 acquires the recognized character string as, for example, text information.

The recognizer 120 associates the recognized character string with time information (the first time, the second time, etc.) corresponding to the character string. Specifically, the recognizer 120 associates the first character string with the first time, and the second character string with the second time. The recognizer 120 may further associate the third character string with the third time. For example, if the time series data is image data or frame image data, the time information is image capture time or reproduction time of the image data or the frame image data. If the time series data is voice data, the time information is recording time or reproducing time of the voice data. The recognizer 120 outputs the recognized character string and the time information corresponding to the character string to the buffer 130. The recognizer 120 may output the recognized character string and the time information corresponding to the character string to the generator 140.

The buffer 130 receives the character string and the time information corresponding to the character string from the recognizer 120. Specifically, the buffer 130 stores the first character string and the first time in association with each other, and the second character string and the second time in association with each other. The buffer 130 may further store the third character string in association with the third time. The buffer 130 may store character strings of a plurality of languages, or may store character strings of only the first language using a language determination process.

The generator 140 acquires, from the buffer 130, the first time and the first character string, and the second time and the second character string. The generator 140 may further acquire the third time and the third character string. The generator 140 generates a resultant character string including at least a part of the first character string and at least a part of the second character string based on a production rule. The generator 140 may receive a character string and time information corresponding to the character string from the recognizer 120.

The production rule includes a concatenation rule using an overlapping character string overlapped between the first character string and the second character string. The production rule may further include a division rule using a linguistic feature of the first character string and the second character string. The linguistic feature includes at least one of a period, a comma, a symbol, and an auxiliary verb relating to a morphological analysis. A specific example of generation of a resultant character string will be described later.

The calculator 141 calculates a score indicating a likelihood of a resultant character string. For example, the calculator 141 collates a resultant-character string with a language model, and calculates a score of the resultant character string based on the collation. Alternatively, the calculator 141 may calculate a score using a dictionary-based method, in which the score is higher if the resultant character string includes a word existing in a word dictionary whereas the score is lower if the resultant character string includes a word not existing in the word dictionary. In this embodiment, a higher score of the resultant character string represents that the likelihood (or appropriateness) as the first language is higher.

The determiner 142 determines whether or not the score of the resultant character string is equal to or higher than a threshold. The determiner 142 outputs the resultant character string if the score is equal to or higher than the threshold.

The generator 140 may control a time interval between character strings acquired from the buffer 130. Specifically, the generator 140 may change, in accordance with a difference between the first character string and the second character string, the time interval between character strings to be acquired from the buffer 130 from the time interval between the first time and the second time, to the time interval between the first time and the third time.

In other words, the generator 140 may generate a resultant character string including an overlapping character string between the first character string and the third character string, by applying a production rule to the first character string and the third character string, not to the first character string and the second character string, depending on the difference between the first character string and the second character string.

Furthermore, the generator 140 may terminate generation of the resultant character string when detecting that a head portion of the character string corresponding to a time coincides with an end portion of the character string corresponding to a later time.

More specifically, for example, the generator 140 may terminate generation of the resultant character string when detecting that a head portion of a fourth character string recognized from fourth data associated with a fourth time prior to the second time coincides with an end portion of the second character string.

The translator 150 receives the resultant character string from the generator 140. The translator 150 machine-translates the resultant character string from the first language into the second language, thereby obtaining a translated character string. The translator 150 can perform various translation processing, such as Rule Based Machine Translation, Example Based Machine Translation, and Statistical Machine Translation. The translator 150 may use human translation, such as Cloud Sourcing, for part or for all of the translation processing.

The language processing apparatus 100 operates in such a manner as is illustrated in FIG. 2. The operation shown in FIG. 2 starts at reception of time serial data by the recognizer 120.

In step S201, the recognizer 120 recognizes two or more character strings from the time series data. Specifically, the recognizer 120 recognizes, from the time series data including the first data corresponding to the first time and the second data corresponding to the second time, the first character string corresponding to the first data and the second character string corresponding to the second data.

In step S202, the buffer 130 stores the two or more character strings and corresponding time information. Specifically, the buffer 130 stores the first character string and the first time in association with each other, and the second character string and the second time in association with each other.

In step S203, the generator 140 generates a resultant character string from the two or more character strings. Specifically, the generator 140 generates a resultant character string including at least a part of the first character string and at least a part of the second character string based on a production rule.

In step S204, the calculator 141 calculates a score of the resultant character string.

In step S205, the determiner 142 determines whether or not the score of the resultant character string is equal to or higher than a threshold. If the score of the resultant character string is equal to or higher than the threshold, the process proceeds to step S206. If not, the process returns to step S201.

In step S206, the translator 150 machine-translates the resultant character string, thereby obtaining a translated character string. Specifically, the translator 150 machine-translates the resultant character string of the first language, thereby obtaining a translated character string of the second language.

Operations of steps S201 and S202 may be asynchronous with operations of the steps S203-S206. Specifically, the recognizer 120 sequentially recognizes character strings one after another from time series data and stores the recognized character string in the buffer 130, before translated character strings for the recognized two or more character strings are generated. The generator 140 acquires character strings one after another from the buffer 130 and generates resultant character strings.

If the recognizer 120 recognizes character strings one after another from the time series data, the recognized 120 may perform sequential processing by re-using the second character string recognized in the previous processing as a first character string, and recognizing a next character string as a second character string.

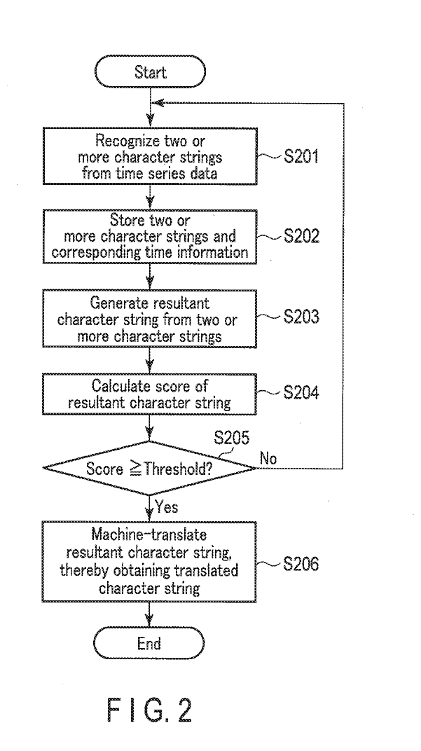

A specific operation of the language processing apparatus 100 will be described using a guidance display board 300 illustrated in FIG. 3A. In the following explanation, it is assumed that the time series data are image data.

The guidance display board 300 includes a static display portion 301 and a dynamic display portion 302. The static display portion 301 represents a region in which the character strings do not change at all, or do not change for a limited period of time. Processing relating to the static display portion 301 maybe performed by conventional character recognition and translation processing. Therefore, in the following, the explanations for the processing will be omitted.

The dynamic display portion 302 represents a region in which the character string is scrolled from right to left to display the entire text. It is assumed that the dynamic display portion 302 repeatedly scrolls the character string “ [symbol] : [symbol] [symbol] [symbol] [symbol] [symbol] (ATTENTION: Carrying dangerous objects into stations and trains is prohibited)” illustrated in FIG. 3B.

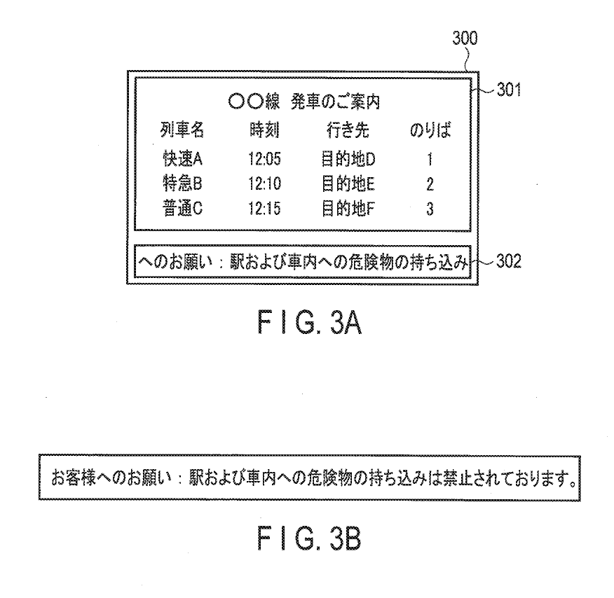

FIG. 4A illustrates image data 401-404 that are images of the dynamic display portion 302 captured as the time elapses. The recognizer 120 recognizes character strings from the image data 401-404 and associates the respective character strings with image capture times of the corresponding image data. The buffer 130 stores the character strings and the image capture times in association with each other.

FIG. 4B illustrates image capture times and character strings, which are stored in the buffer 130. The buffer 130 stores the character string “ [symbol] : [symbol] ” associated with the corresponding image capture time t₀, the character string “ [symbol] : [symbol] [symbol] ” associated with the corresponding image capture time t₁, the character string “ [symbol] [symbol] [symbol] ” associated with the corresponding image capture time t₂, and the character string “ [symbol] [symbol] [symbol] :” associated with the corresponding image capture time t₃.

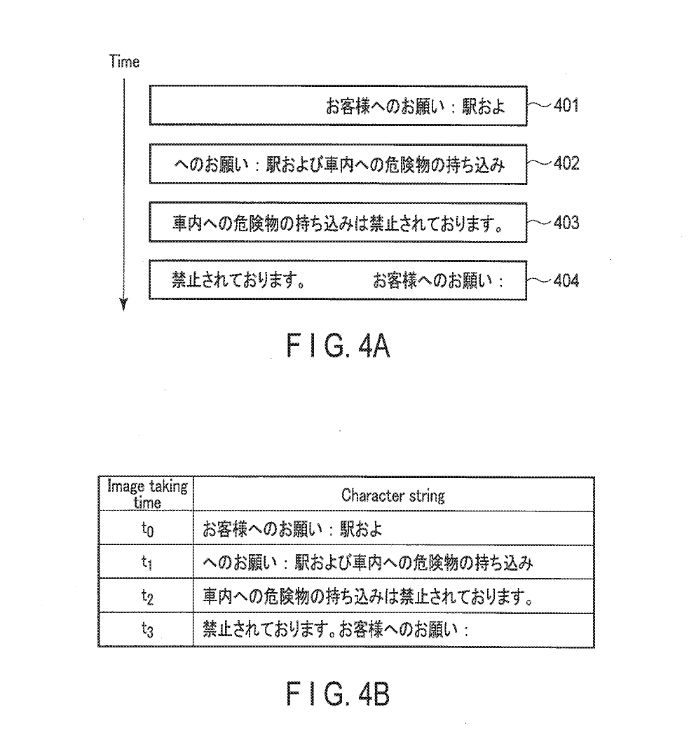

FIG. 5 illustrates production rules used in the generator 140. The generator 140 may divide a character-string at the position of a punctuation mark using “Division rule 1”. The generator 140 may divide a character string at the position of a specific symbol using “Division rule 2”. The generator 140 may divide a character string at the position of a specific expression using “Division rule 3”.

Furthermore, the generator 140 may concatenate a character string corresponding to time tₙ₊₁ or later after a character string corresponding to time tₙ using “Concatenation rule 1”, so that the overlapping character string can be longest (forward concatenation). The generator 140 may concatenate a character string corresponding to time t₁ or later before a character string corresponding to time t, using “Concatenation rule 2”, so that the overlapping character string can be longest (reverse concatenation).

The generator 140 may apply any of the above rules a plurality of times or may apply a combination of any of the rules, as long as the order of the character strings does not change. The rules illustrated in FIG. 5 may be appropriately changed in accordance with linguistic phenomena of the first language.

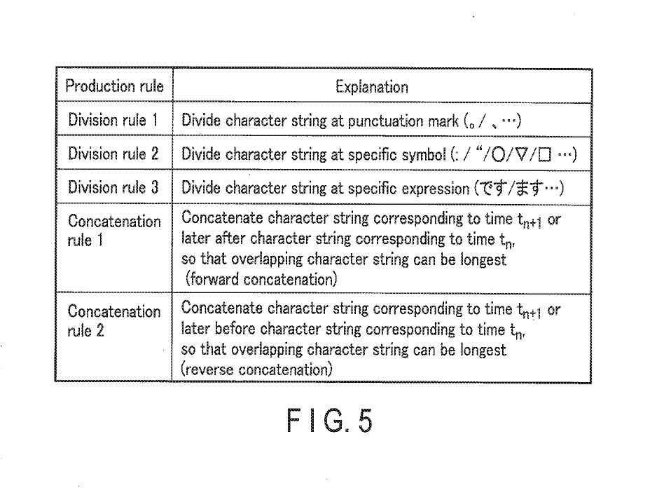

FIG. 6A illustrates a language model used in the calculator 141. A language model is constructed by, for example, calculating probabilities of sequences of morphemes (n-gram) from a large amount of language data. In FIG. 6A, <s> represents a beginning of a sentence, <unk> represents an unknown word, and </s> represents an end of a sentence. A language model may be constructed by a neural network base as well as the n-gram base described above.

FIG. 6B illustrates resultant character strings generated by the generator 140 and scores of the resultant character strings calculated by the calculator 141. The generator 140 generates resultant character strings shown in FIG. 6B by using production rules shown in FIG. 5 for character strings shown in FIG. 4B. The calculator 141 calculates scores by collating the resultant character strings shown in FIG. 6B with the language model shown in FIG. 6A.

For example, the first character string is “ [symbol] : [symbol] [symbol] ” corresponding to the image capture time t₁ in FIG. 4B, and the second character string is “ [symbol] [symbol] [symbol] ” corresponding to the image capture time t₂ in FIG. 4B. The generator 140 generates the resultant character string “ [symbol] [symbol] [symbol] [symbol] (Carrying dangerous objects into stations and trains is prohibited)” from the character string corresponding to the image capture time t₁ and the character string corresponding to the image capture time t₂. Specifically, the generator 140 divides the character string “ [symbol] : [symbol] [symbol] ” at the symbol “:” using “Division rule 2” in FIG. 5, and generates a character string A “ [symbol] :” and a character string B “ [symbol] [symbol] ” . Furthermore, the generator 140 concatenates a character string “ [symbol] [symbol] [symbol] ” after the character string B “ [symbol] [symbol] ” at the overlapping portion “ [symbol] [symbol] ” using “Concatenation rule 1” in FIG. 5, thereby generating the resultant character string “ [symbol] [symbol] [symbol] (Carrying dangerous objects into stations and trains is prohibited)”.

The calculator 141 calculates the score “2” and the score “4” respectively for the resultant character string “ [symbol] ” and the resultant character string “ [symbol] : [symbol] [symbol] ” in FIG. 6B. Specifically, the resultant character string “ [symbol] ” includes an unknown word and is incomplete as a Japanese sentence. The resultant character string “ [symbol] : [symbol] [symbol] [symbol] ” ends with an indeclinable word. Therefore, the calculated scores of these resultant character strings are lower than those of the other resultant character strings of FIG. 6B.

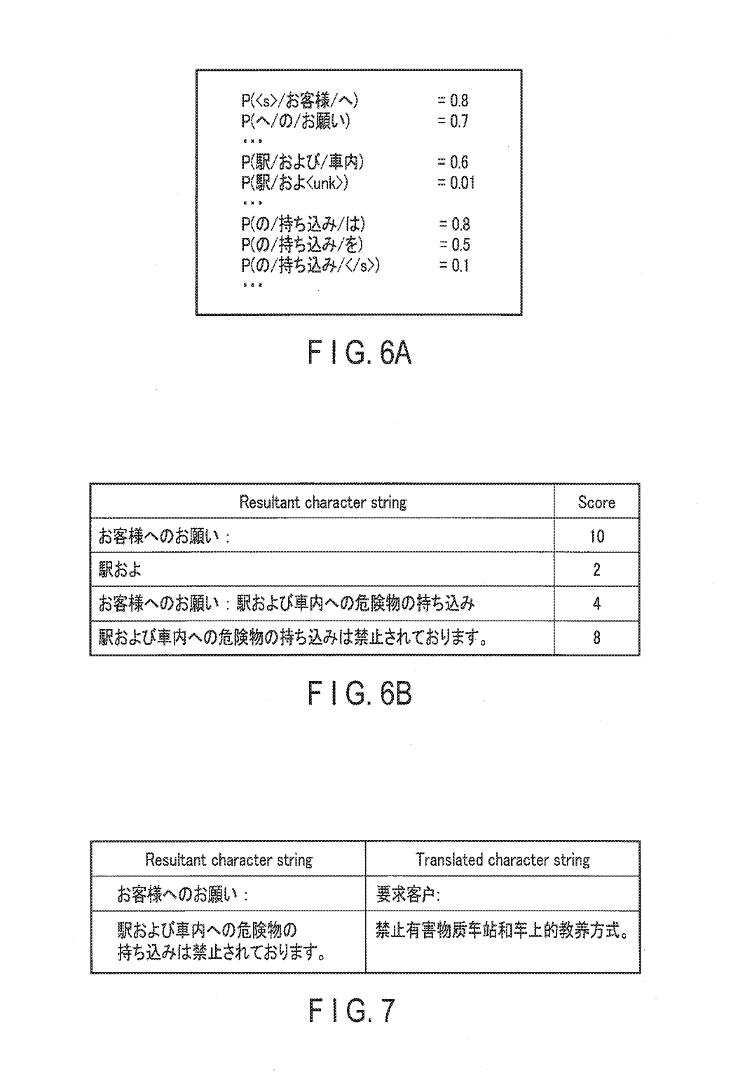

FIG. 7 illustrates a resultant character string output by the determiner 142, and a translated character string translated by the translator 150. If a threshold of a score to be determined is “5”, the determiner 142 outputs the resultant character string “ [symbol] : (ATTENTION:)” and the resultant character string “ [symbol] [symbol] [symbol] [symbol] (Carrying dangerous objects into stations and trains is prohibited)” shown in FIG. 6B, which have scores higher than the threshold.

The translator 150 machine-translates the resultant character string “ [symbol] : (ATTENTION)” in FIG. 7 from Japanese to Chinese, thereby obtaining a translated character string (1) presented below.

[symbol]

(1)

The translator 150 further machine-translates the resultant character string “ [symbol] [symbol] [symbol] [symbol] (Carrying dangerous objects into stations and trains is prohibited)” in FIG. 7 from Japanese to Chinese, thereby obtaining a translated character string (2) presented below.

[symbol]

[symbol]

(2)

The translator 150 can sequentially translate character strings output from the determiner 142.

As described above, the language processing apparatus according to the first embodiment recognizes at least a first character string corresponding to first data and a second character string corresponding to second data and including a part identical to a part of the first character string from time series data including the first data corresponding to a first time and the second data corresponding to a second time later than the first time. Furthermore, the language processing apparatus generates a resultant character string including at lea part of the first character string and at least a part of the second character string based on a production rule. Therefore, with the language processing apparatus of the embodiment, even if all character strings are not indicated at a time, a translation unit can be generated to enable high-precision machine translation.

### Second Embodiment

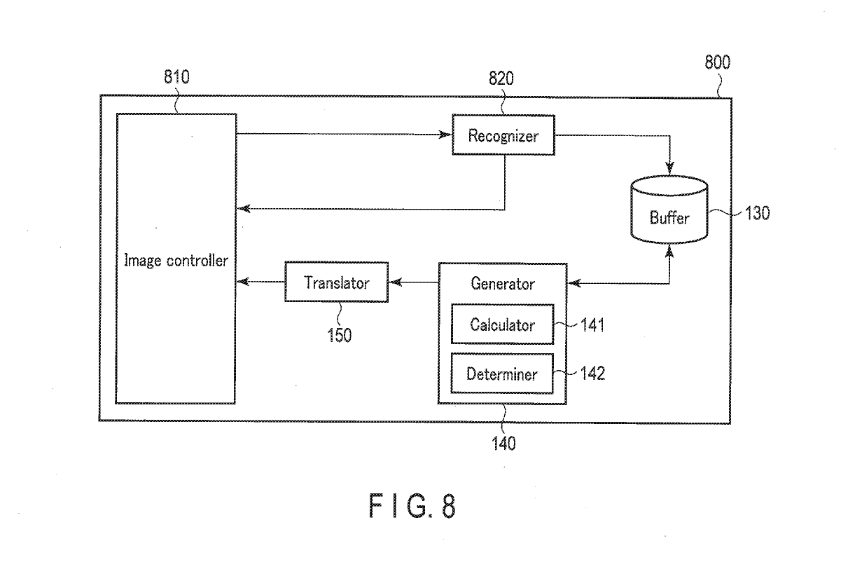

As illustrated in FIG. 8, a language processing apparatus 800 of the second embodiment comprises an image controller 810, a recognizer 820, a buffer 130, a generator 140, a calculator 141, a determiner 142, and a translator 150. The language processing apparatus 800 differs from the language processing apparatus 100 in that the image controller is additionally provided, an acquirer is included in the image controller, and an additional operation is added to the recognizer. In the following, differences in operation of the image controller 810 and the recognizer 820 from those of the corresponding elements of the language processing apparatus 100 will be explained.

The image controller 810 receives time series data from an image-capture device (not shown). In this embodiment, time series data is, for example, image data or frame image data. The image controller 810 outputs the time series data to the recognizer 820. The image controller 810 receives a character string area (to be described later) from the recognizer 820, and a translated character string from the translator 150. The image controller 810 generates translated image data by replacing a character string of a first language included in the character string area with a character string of a second language.

The recognizer 820 receives time series data from the image controller 810. The recognizer 820 recognizes, from the time series data including the first data corresponding to a first time and the second data corresponding to a second time, at least a first character string corresponding to first data and a second character string corresponding to second data.

The recognizer 820 further recognizes a character string area including the first character string and the second character string. The character string area is, for example, an area corresponding to the dynamic display portion 302 shown in FIG. 3A. The recognizer 820 outputs the character string area to the image controller 810.

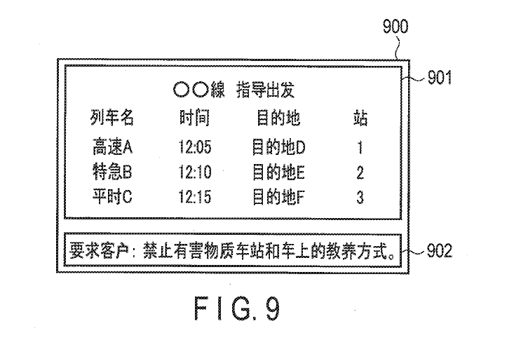

FIG. 9 illustrates translated image data 900, which is a translation of the display of the guidance display board 300 shown in FIG. 3A. The translated image data 900 includes a static display portion 901 and a dynamic display portion 902. Processing relating to the static display portion 901 may be performed by conventional character recognition, translation, and replacement processing. Therefore, in the following, the explanations for the processing will be omitted.

The image controller 810 sequentially generates translated image data by replacing a character string of the first language (Japanese) included in the dynamic display portion 302 with a character string of the second language (Chinese). For example, the character string of Japanese is the resultant character string “ [symbol] [symbol] [symbol] [symbol] (Attention: Carrying dangerous objects into stations and trains is prohibited)” illustrated in FIG. 7.

The translator 150 machine-translates the resultant character string from Japanese to Chinese, thereby obtaining a translated character string (3) presented below.

┌ [symbol] : [symbol] [symbol] ┘ (3)

The image controller 810 generates translated image data by replacing the character string of Japanese with the translated character string (3) so as to display it within the area (character string area) of the dynamic display portion 902. The image controller 810 may adjust a font size or make a line feed at a discretionary position when the character string is replaced. Furthermore, the image controller 810 may expand the character string area, or may scroll the character string over successive translated image data.

As described above, the language processing apparatus according to the second embodiment further recognizes a character string area including the first character string and the second character string. Furthermore, the language processing apparatus generates translated image data by replacing the character string of the first language included in the character string area with a character string of the second language. Therefore, with the language processing apparatus of this embodiment, even if all character strings are not indicated at a time, a translation unit can be generated to enable high-precision machine translation, and translated image data can be sequentially presented.

The instructions indicated in the operation procedure of the above-described embodiments can be carried out based on a software program. It is possible to configure a general-purpose calculating system to store this program in advance and to read the program in order to achieve the same advantageous effects as those achieved by the language processing apparatus of the embodiments described above.

The instructions in the embodiments described above are recorded in a magnetic disc (flexible disc, hard disc, etc.), an optical disc (CD-ROM, CD-R, CD-RW, DVD-ROM, DVD±R, DVD±RW, etc.), a semiconductor memory, or similar storage medium, as a program executable by a computer. As long as a storage medium is readable by a computer or a built-in system, any storage type can be adopted. An operation similar to the operation of the language processing apparatus of the above-described embodiments can be realized if a computer reads a program from the storage medium, and executes the instructions written in the program on the CPU based on the program. A program can be obtained or read by a computer through a network, of course.

Furthermore, an operating system (OS) working on a computer, database management software, middleware (MW) of a network, etc. may execute a part of processes for realizing the present embodiments based on instructions from a program installed from a storage medium onto a computer, or onto a built-in system.

Furthermore, the storage medium according to the embodiments is not limited to a medium independent from a system or a built-in system; a storage medium storing or temporarily storing a program downloaded through LAN or the Internet, etc. is also included as the storage medium according to the embodiments.

Furthermore, a storage medium is not limited to one; when the process according to the present embodiments is carried out using multiple storage media, these storage media are included as a storage medium according to the embodiments, and can take any configuration.

The computer adopted in the embodiments is not limited to a PC; it may be a processing unit included in an information processing device, a multifunctional mobile phone, a microcomputer, etc., and a device and apparatus that can realize the functions of the embodiments by a program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A language processing apparatus comprising:
a recognizer that recognizes a first character string of a first language from first data associated with a first time and recognizes a second character string of the first language including a first overlapping character string which overlaps with the first character string from second data associated with a second time later than the first time; and
a generator that applies a production rule to the first character string and the second character string to generate a first resultant character string of the first language including the first overlapping character string.

2. The apparatus according to claim 1, wherein the first data and the second data are either image data corresponding to two screens acquired by capturing an image of an object including character information at different times, or two frames of image data included in a moving picture acquired by movie-recording an object including character information.

3. The apparatus according to claim 1, further comprising a translator that machine-translates the first character string to obtain a translated character string of a second language different from the first language.

4. The apparatus according to claim 3, wherein:
the first data is image data including a first character string area in which at least the first character string is displayed;
the second data is image data, including a second character string area in which at least the second character string is displayed; and
the recognizer further recognizes the first character string area from the first data and the second character string area from the second data,
the apparatus further comprising an image controller that sequentially generates translated image data obtained by replacing the character string displayed in each of the first character string area and the second character string area in the first data and the second data with the translated character string.

5. The apparatus according to claim 1, wherein the production rule includes a concatenation rule using the first overlapping character string.

6. The apparatus according to claim 5, wherein the production rule further includes a division rule using a linguistic feature of the first character string and the second character string.

7. The apparatus according to claim 6, wherein the linguistic feature includes at least one of a period, a comma, a symbol, and an auxiliary verb.

8. The apparatus according to claim 1, wherein
the generator further includes:
a calculator that calculates a score indicating a likelihood of the first resultant character string; and
a determiner that determines whether or not the score is equal to or higher than a threshold, and wherein
the generator keeps the first resultant character string from being output, when the score is lower than the threshold.

9. The apparatus according to claim 8, wherein the calculator collates the first resultant character string with a language model to calculate the score.

10. The apparatus according to claim 1, further comprising
a buffer that stores the first character string in association with the first time, and the second character string in association with the second time.

11. The apparatus according to claim 10, wherein:
the recognizer further recognizes a third character string of the first language including a second overlapping character string, which overlaps with the first character string, from third data associated with a third time later than the second time;
the buffer stores the third character string in association with the third time; and
the generator applies the production rule to the first character string and the third character string to generate a second resultant character string of the first language including the second overlapping character string, instead of generating the first resultant character string, depending on a difference between the first character string and the second character string.

12. The apparatus according to claim 1, wherein the generator terminates generation of the first resultant character string when the generator detects that a head portion of a fourth character string of the first language recognized from fourth data associated with a fourth time prior to the second time coincides with an end portion of the second character string.

13. A language processing method comprising:
recognizing a first character string of a first language from first data associated with a first time;
recognizing a second character string of the first language including a first overlapping character string which overlaps with the first character string from second data associated with a second time later than the first time; and
applying a production rule to the first character string and the second character string to generate a first resultant character string of the first language including the first overlapping character string.

14. A non-transitory computer readable storage medium storing instructions of a computer program which when executed by a computer results in performance of steps comprising:
recognizing a first character string of a first language from first data associated with a first time;
recognizing a second character string of the first language including a first overlapping character string which overlaps with the first character string from second data associated with a second time later than the first time; and
applying a production rule to the first character string and the second character string to generate a first resultant character ring of the first language including the first overlapping character string.
